(19) United States
(12) Patent Application Publication
(10) Pub. No.: US 2022/0081966 A1
(43) Pub. Date: Mar. 17, 2022

(54) Deployable Shell Roll-up Door

(71) Applicant: James G. Arendts, Thayne, WY (US)

(72) Inventor: James G. Arendts, Thayne, WY (US)

(21) Appl. No.: 17/022,729

(22) Filed: Sep. 16, 2020

(51) Int. Cl. E06B 9/15; E06B 9/58; E06B 9/62

(52) U.S. Cl. CPC E06B 9/15; E06B 2009/1566; E06B 9/62; E06B 9/58

(57) ABSTRACT

Two embodiments of a roll-up door system, based on deployable shell designs, are disclosed. Each embodiment consists of: an axle providing continuity to the embodiment, a door panel assembly, two mounting and support assemblies, and two door alignment and support tracks. Each embodiment has the following attributes: large lateral load strength to weight ratio, good natural heat flow insulation, weather tightness and, with proper jamb seals, differential pressure boundary capability.

### PRIOR ART—REFERENCES

The following is a tabulation of some prior art that presently appears relevant:

U.S. Patents

| U.S. Pat. No. | Kind Code | Issue Date | Patentee |
|---|---|---|---|
| 5,129,442 | | 1992 Jul. 14 | Warner |
| 5,172,744 | | 1992 Dec. 22 | Finch et al. |
| 5,632,317 | | 1997 May 27 | Krupke et al. |
| 6,065,525 | | 2000 May 23 | Wells |
| 6,152,207 | | 2000 Nov. 28 | Varley |
| 6,883,577 | B2 | 2005 May 26 | Frede |
| 7,131,481 | B2 | 2006 Nov. 7 | Varley et al. |
| 7,231,953 | B2 | 2007 Jun. 19 | Varley et al. |
| 8,291,960 | B2 | 2012 Oct. 23 | Bowman |
| 8,684,064 | B2 | 2014 Apr. 1 | Frede |
| 9,187,953 | B2 | 2015 Nov. 17 | Drifka et al. |
| 9,260,911 | B2 | 2016 Feb. 16 | Gontarski et al. |
| 9,637,972 | B2 | 2017 May 2 | Miller et al. |
| 10,246,932 | B2 | 2019 Apr. 2 | Arendts |
| 10,344,527 | B2 | 2019 Jul. 9 | Balbach et al. |
| 10,428566 | B2 | 2019 Oct. 1 | Arendts |

U.S. Patent Application Publications

| Publication Nr. | Kind Code | Pub. Date | Applicant |
|---|---|---|---|
| 20160177624 | A1 | 2016 Jun. 23 | Palencia et al. |
| 20160348424 | A1 | 2016 Dec. 1 | Lorenzani et al. |
| 20160348430 | A1 | 2016 Dec. 1 | Lorenzani et al. |
| 20160376841 | A1 | 2016 Dec. 29 | Hentschel |
| 20190071923 | A1 | 2019 Mar. 7 | Ouyang et al. |

### NONPATENT LITERATURE DOCUMENTS

Arendts, J. G., “Load Distribution in Simply Supported Concrete Box Girder Highway Bridges,” thesis presented to the Iowa State University, at Ames, Iowa, in 1969, in partial fulfillment of the requirements for the degree of Doctor of Philosophy, http://lib.dr.iastate.edu/rtd, paper 3623.
Arendts, J. G. and Sanders, W. W., Jr., “Concrete Box-Girder Bridges as Sandwich Plates,” Proceedings of the American Society of Civil Engineers, Journal of the Structural Division, November, 1970.

### PRIOR ART—DISCUSSION

Overhead doors are used for a variety of applications, from refrigerated area closures to light aircraft hangar doors. Design requirements include thermal insulation, structural resistance to lateral loads, such as pressure induced by wind, and security requirements.

Existing overhead door designs are classified, in U.S. patent Ser. No. 10/428,566, into two general categories: (a) single and dual panel designs and (b) designs primarily comprised of a plurality of panels or slats which are connected by belts or hinge mechanisms. General category (a) is further defined to include: (a1) rigid panel designs, (a2) flexible single sheet panel designs and (a3) flexible multi-layer panel designs.

Overhead door designs may also be classified by the method of securing the door in its open configuration: rolled into a substantially cylindrical configuration (roll-up), or supported in a substantially horizontal configuration. The remainder of this discussion is concerned with only the roll-up configuration. Existing roll-up door design art generally falls into design category (a2) single flexible sheet, (a3) flexible multi-layer panel or (b) multiple connected panels or slats.

(a2-1) Complete recent designs of single flexible panel roll-up overhead doors are represented by U.S. Pat. Nos. 5,129,442, 5,632,317, 7,131,481, 7,231,953, 9,637,972 and U.S. Patent Application Publications 20160177624, 20160273824, 20160348424, 20160348430, 20160376841. A challenge shared by all of these designs is resistance to lateral loading created by winds impinging on the respective door. Flexible panel designs containing minimal to nil intermediate stiffening members resist lateral wind loads through panel tensile membrane stress induced by lateral deformation of the panel when loaded. Nearly all of these designs contain provision for restraining the membrane stresses.

(a2-2) U.S. Pat. No. 5,129,442 presents a design where all resistance membrane stress is transmitted vertically to top and bottom structures. In this case moderate wind loading could result in separation of the panel sides from the door frame. U.S. Pat. No. 5,632,317 presents a similar design with the addition of a single horizontal “wind bar” at mid-door height. In this case, the added bar relieves some of the lateral deformation induced stress. However, moderate to high wind loading could create a side separation problem. U.S. Pat. Nos. 7,131,481 and 7,231,953 present designs where relatively widely spaced horizontal stiffener struts are incorporated into the panel design and “wind locks” (horizontal panel displacement constraints) are added to the panel vertical sides. U.S. Pat. No. 9,637,972 presents a similar design where the horizontal struts are replaced by two separated vertical guide channels. Both of these designs result in a relatively greater ability for lateral load resistance with the penalty of greater weight and complexity.

(a2-3) Various modifications to parts of door designs are disclosed U.S. Pat. Nos. 6,152,207, 8,291,960, 9,187,953 and 9,260,911. With few exceptions, the modifications suggest more efficient or simplified details for increasing single flexible panel door design structural resistance to lateral loads.

(a2-4) U.S. Patent Application Publications 20160376841, 20160348430, 20160348424 and 20160177624 present relatively simple unstiffened panel designs where the panel vertical edges have horizontal displacement restraints which slide within vertical guides. This results in relatively simple and inexpensive designs with relatively low resistance to lateral wind loads.

(a3) A roll-up flexible multi-layer panel design is disclosed in U.S. Pat. No. 6,065,525. In this design, a planar flexible sheet is intermittently connected to a flexible corrugated panel where the axes of corrugations are oriented horizontally. An advantage of this design is that the corrugated panel more efficiently resists lateral wind loads through bending of the corrugations. However, due to the intermittent connection of the two panels, the full composite bending strength of both flexible panels is not developed. The relatively small increase of this dual panel design's ability to distribute lateral wind loads is not justified by the increased complexity and weight of the design.

(b) Overhead roll-up door, multi panel designs are ubiquitous, usually employed where security is a significant design requirement. U.S. Pat. Nos. 5,172,744, 6,883,577, 8,684,064, 10,344,527 and U.S. Patent Application Publication 20190071923 depict designs in this category. As described in most of these designs, the individual panels are compact, having large aspect ratio and bending stiffness with resulting favorable resistance to lateral wind loads. This results in relatively heavy door designs and, due to the large number of panel-to-panel connections, non-optimal weather tightness and thermal insulation.

Arendts (1969), as summarized in Arendts and Sanders (1970), shows that structures, such as box girder bridges, consisting of two relatively thin elastic sheets connected by a plurality of transverse webs, theoretically and actually behave as sandwich plates with orthogonally differing core transverse shear properties. Such a structural panel may be modified, through hinging the web-sheet connections, so that it is flexible. Overall stiffness and strength of the panel is not significantly reduced by hinging the webs and stability is achieved through proper support of the overall structural system. Arendts, in U.S. patent Ser. No. 10/246,932, discloses a deployable structural system consisting of two relatively thin elastic sheets connected by a plurality of elongated parallel web panels. These connections are hinged to form a composite panel which may be elastically transitioned from a nearly planar configuration to a substantially cylindrical rolled-up configuration. Two embodiments of a roll-up door design, utilizing this deployable structural system, are disclosed herein. Advantageous properties of this design are summarized below.

### SUMMARY

Existing roll-up door design art suffers from some deficiencies:
Single flexible panel designs are challenged when relatively large transverse wind-induced loads are considered; auxiliary structures must usually be employed.
Multiple connected panel designs are relatively complex with a relatively low transverse load to structure weight ratio; transverse air flow limitation is difficult.
Both of the above design types have limited capability for transverse heat flow insulation.

The present door design embodiments, in the closed configuration, have large composite thin sheet bending stiffness with resulting large allowable transverse load to structure weight ratio. Additionally, the cellular nature of the designs results in naturally large transverse heat flow insulation.

### Advantages

These deployable shell roll-up door design embodiments have the following advantages when compared with other existing roll-up door system designs:

(a) Very large allowable transverse load to structural weight ratio,

(b) Very large lateral stiffness to structural weight ratio,

(c) Weather tightness,

(d) Ability to provide closure for pressure boundaries,

(e) Native transverse heat flow insulation due to constrained air in the panel void spaces,

(f) Ability to quickly and quietly transition the door between closed and open configurations.

### DRAWINGS—FIGURES

In the drawings, closely related figures have the same number but differing alphabetical suffixes.

FIG. 1A. Overall view of door geometry G1, closed configuration;

FIG. 1B. Overall view of door geometry G1, open configuration;

FIG. 2A. Vertical cross-section of door G1, closed configuration;

FIG. 2B. Vertical cross-section of door G1, open configuration;

FIG. 3A. Side view of door G1, less panels, side A;

FIG. 3B. Vertical cross-section of door G1, less panels, side A;

FIG. 4A. Side view of door G1, less panels, side B;

FIG. 4B. Vertical cross-section of door G1, less panels, side B;

FIG. 5A. Overall view of door geometry G2, closed configuration;

FIG. 5B. Overall view of door geometry G2, open configuration;

FIG. 6A. Vertical cross-section of door G2, closed configuration;

FIG. 6B. Vertical Cross-Section of Door G2, Open Configuration;

FIG. 7A. Side view of door G2, less panels, side A;

FIG. 7B. Vertical cross-section of door G2, less panels, side A;

FIG. 8A. Side view of door G2, less panels, side B;

FIG. 8B. Vertical cross-section of door G2, less panels, side B;

FIG. 9A. Side view of cam plate and mandrel, door G2—side B;

FIG. 9B. Cross-section of cam plate, door G2—side B;

FIG. 9C. Cross-section detail, sheet anchor bar-mandrel connection;

FIG. 9D. Roller-track detail;

FIG. 9E. Partially open web detail;

FIG. 10. Design considerations, nomenclature;

FIG. 11. Retractable roof additional embodiment cross-section;

FIG. 12A. Retractable greenhouse additional embodiment cross-section, closed configuration;

FIG. 12B. Retractable greenhouse additional embodiment cross-section, open configuration.

Drawings - Reference Numerals

| | |
|---|---|
| 11 | door panel assembly, G1 - closed |
| 12 | door mount and support assembly, G1 |
| 13 | door alignment and support track, G1 |
| 14 | door panel assembly, G1 - open |
| 20 | typical roller |
| 21 | mandrel |
| 22 | support and guide roller |
| 23 | inner surface elastic sheet, G1 |
| 24 | outer surface elastic sheet, G1 |
| 25 | typical web, G1 |
| 26 | foot web, G1 |
| 27 | sheet anchor bar |
| 28 | axle |
| 29 | typical hinge |
| 30 | support frame, G1 - side A |
| 31 | mandrel end |
| 32 | guide roller support leg, G1 |
| 33 | spring anchor plate, G1 |
| 34 | typical spring anchor plate bolt |
| 35 | spring anchor sleeve |
| 36 | frame bearing |
| 37 | inner mandrel bearing |
| 38 | outer mandrel bearing |
| 39 | counter-weight spring |
| 41 | support frame, G1 - side B |
| 42 | bearing support ring |
| 43 | spacer |
| 44 | spring - axle connection flange |
| 45 | typical spring anchor sleeve screw |
| 51 | door panel assembly, G2 - closed |
| 52 | door mount and support assembly, G2 |
| 53 | door alignment and support track, G2 |
| 54 | door panel assembly, G2 - open |
| 61 | inner surface elastic sheet, G2 |
| 62 | outer surface elastic sheet, G2 |
| 63 | typical web, G2 |
| 64 | foot web, G2 |
| 71 | support frame, G2 - side A |
| 72 | guide roller support leg, G2 |
| 73 | spring anchor plate, G2 |
| 74 | typical linear bearing |
| 75 | linear bearing shaft |
| 76 | cam plate, side A |
| 77 | cam pin |
| 78 | bearing support, side A |
| 81 | support frame, G2 - side B |
| 82 | cam plate, side B |
| 83 | bearing support, side B |
| 90 | cam plate groove |
| 91 | typical sheet anchor bar connection screw |
| 92 | typical track section |
| 93 | typical inner sheet section |
| 94 | typical outer sheet section |
| 95 | typical hinge section |
| 96 | typical web section |
| 101 | ratio k and constant C definitions |
| 102 | linear dimension x definition, G1 |
| 103 | curved dimension r definition, G1 |
| 104 | angle integral definition, G1 |
| 105 | linear dimension y definition, G2 |
| 106 | curved dimension s definition, G2 |
| 107 | angle integral definition, G2 |
| 121 | roof panel, closed configuration |
| 122 | roof panel retracted configuration |
| 123 | central roof beam |

### EMBODIMENT DESCRIPTIONS

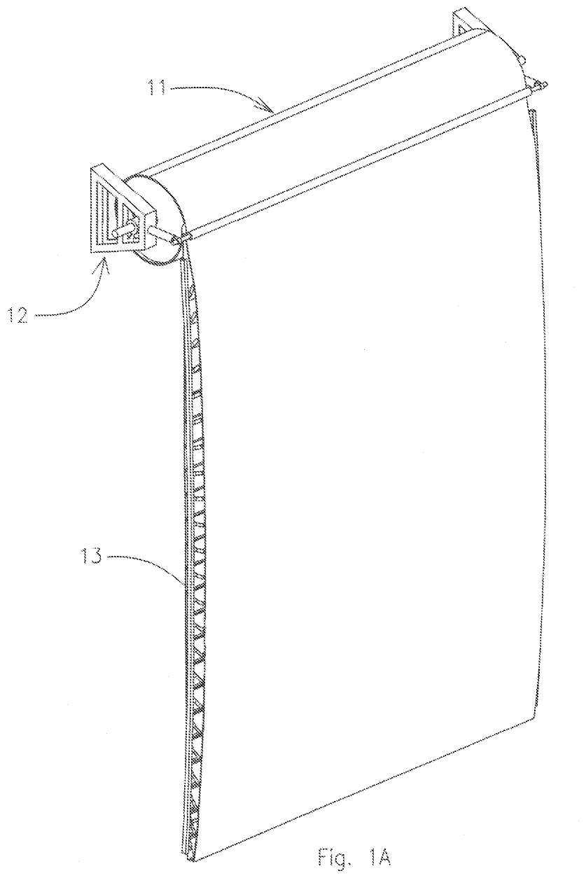

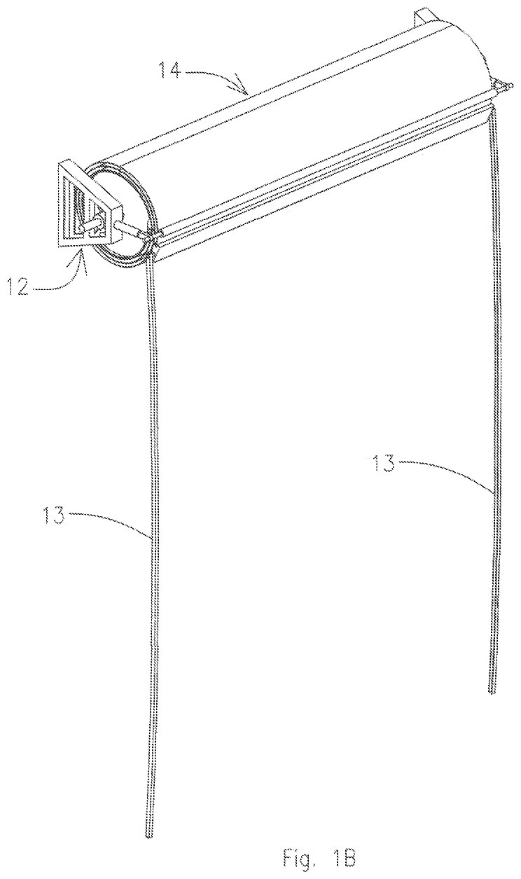

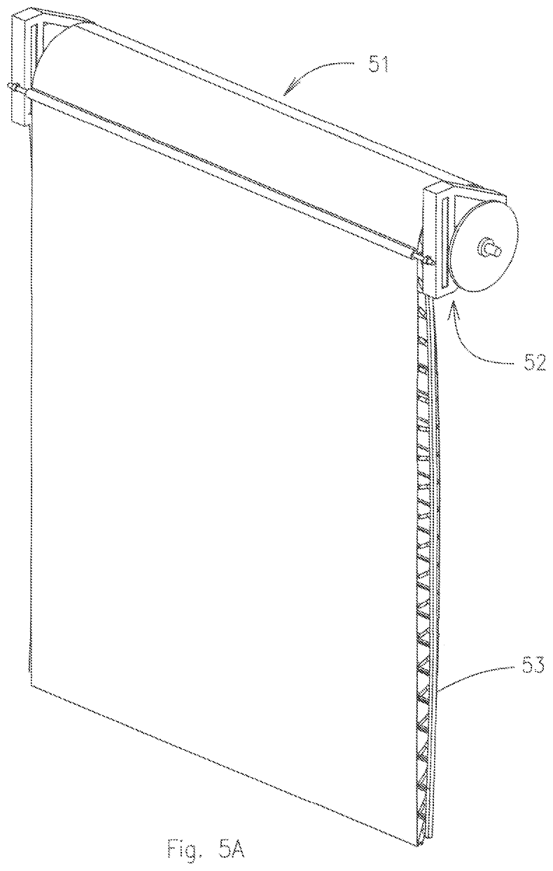

FIGS. 1A through 4B pertain to the first door embodiment and FIGS. 5A through 8B pertain to the second door embodiment. Descriptions of the two embodiments, representing two geometries, herein named G1 and G2, follow. These geometries differ in the manner in which each door embodiment is supported when in the closed configuration: geometry G1 represents a planar inner sheet, FIG. 1A, whereas geometry G2 represents a planar outer sheet, FIG. 5A. Generally, the planar sheet is in contact with a door jamb, or jamb seal gasket, where geometry G1 applies to designs where the rolled-up door is on the jamb side and geometry G2 is applicable to the rolled-up door being opposite the jamb.

### First Embodiment, Door Panel Assembly—FIGS. 1A through 2B, 9A and 9C through 9E

Overall views of the first embodiment are illustrated in FIGS. 1A and 1B showing the G1 geometry closed and open configurations, respectively. Shown are: the door panel assembly (closed) 11, door mount and support assemblies 12, door alignment and support track 13 and the door panel assembly (open) 14.

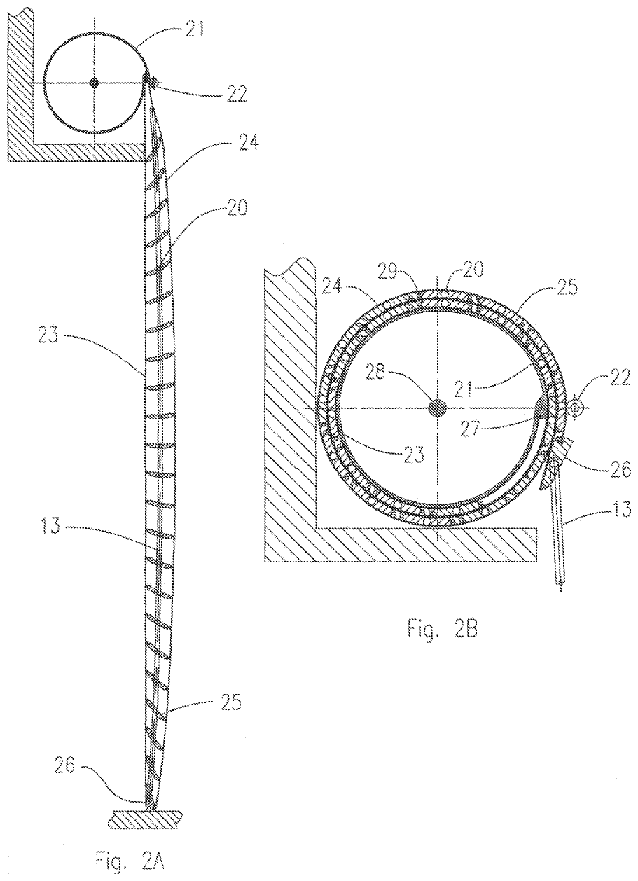

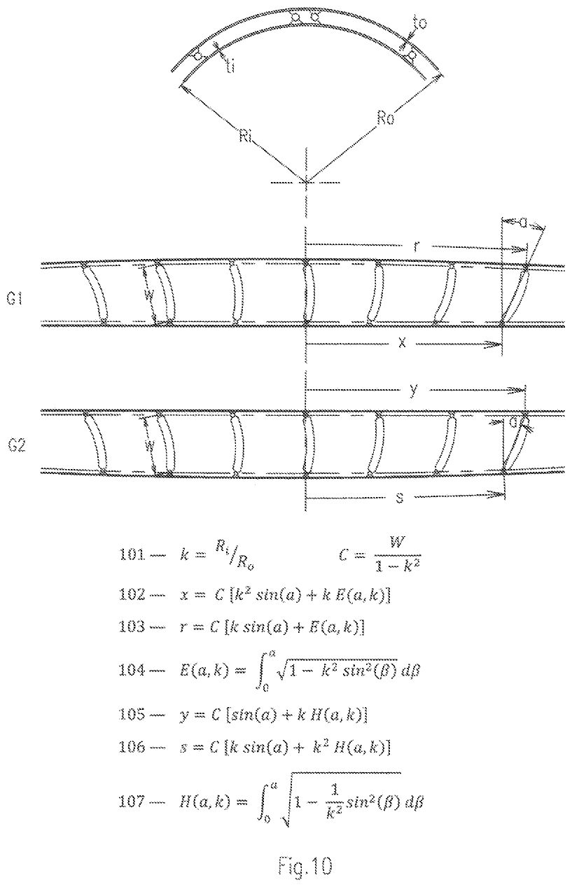

Details of the door panel assembly are illustrated in FIGS. 2A and 2B showing cross-sections of the G1 panels in the closed and open configurations, respectively. An inner surface elastic sheet 23 is connected to an outer surface elastic sheet 24 by a plurality of high aspect ratio curved webs 25 by means of hinges 29. The upper edges of both elastic sheets are rigidly connected to an anchor bar 27 which is, in turn, connected to a cylindrical mandrel 21 which rotates about an axle 28. The bottom-most web 26 is configured to be a floor contact seal. Support rollers 20 are attached to all of the curved web 25 ends, as well as the floor contact web 26 ends. Also shown are the support tracks 13 within which the support rollers 20 are confined when the door is closed. FIGS. 9A and 9C illustrate details of the anchor bar 27 and mandrel 21 connection by means of recessed screws 91. FIG. 9D shows details of the roller 20—track section 92 interface, where the track may be the “C” cross-section galvanized steel track commonly used for overhead door support applications. FIG. 9E illustrates a typical web 96—sheet 93, 94—roller 20 and hinge 95 interface for a partially open door.

A support and guide roller 22, which is connected to the door mount and support assemblies 12, is provided. It is noted that this roller does not transmit a large radial force to the rolled elastic sheets since shell transverse shear force is absent for circular cylindrical bending displacement of the thin elastic sheets.

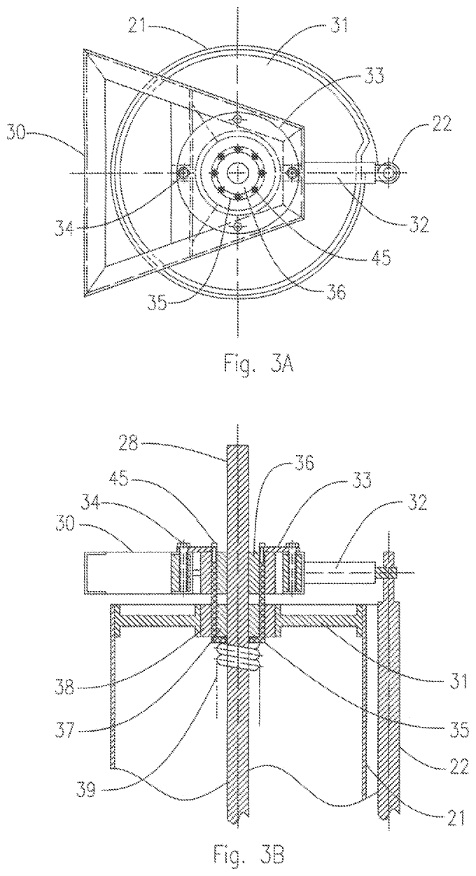

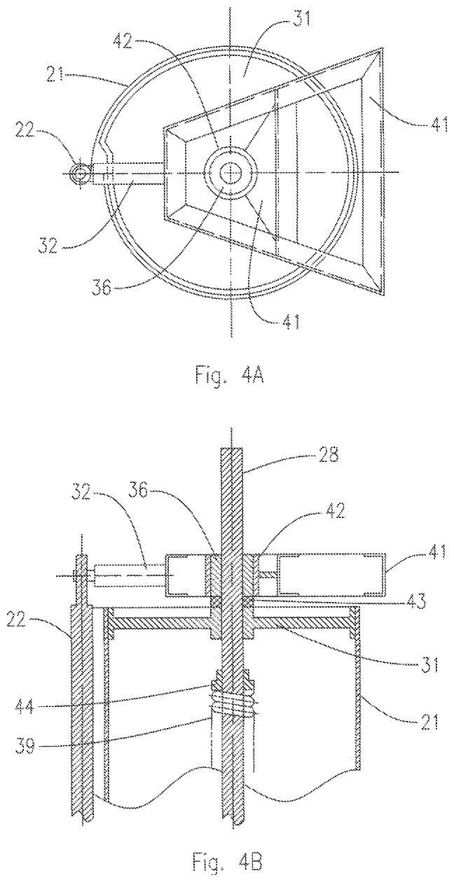

### First Embodiment, Door Mount and Support Assemblies—FIGS. 3A through 4B

The first embodiment contains two nearly identical mount and support assemblies located at both ends of their respective mandrels. Designs of the assemblies differ due to inclusion of a weight counterbalance spring mechanism. The designs are designated “side A” and “side B” where side A includes a counterweight spring pretension and frame anchor mechanism and side B includes a spring-axle connection. The first embodiment support assembly designs constrain all radial displacement of the axle-mandrel assembly.

A side view of side A support assembly is shown in FIG. 3A. The corresponding cross-section is shown in FIG. 3B. Frameworks 30, shown as welded channel sections, provide support of the axle-mandrel assembly and counterweight pretension assembly through the frame bearing 36. The axle-mandrel assembly consists of: the axle 28, inner mandrel bearing 37, outer mandrel bearing 38, mandrel end 31 and mandrel 21. The counterweight pretension assembly consists of: the spring anchor sleeve 35, spring anchor plate 33, spring anchor sleeve screws 45 and spring anchor plate bolts 34. To obtain the desired counterweight spring torque, the spring 39, which is affixed to the spring anchor sleeve, is rotated via rotation of the spring anchor plate with axle rotation restrained. After the desired preload torque is obtained, the anchor plate is affixed to the respective support frame with the anchor plate bolts. The guide roller 22 is supported by the axially sprung support leg 32 which is attached to the support frame 30.

A side view of the side B support assembly is shown in FIG. 4A. A corresponding cross-section is shown in FIG. 4B. It is seen that a difference between Side B and side A support assemblies is the omission of the counterweight pretension assembly and addition of the spring-axle connection flange 44 which is rigidly affixed to the axle and spring. In addition, the inner and outer mandrel bearings are omitted in the side B support since the mandrel end 31 is affixed to the axle 28.

### Second Embodiment, Door Panel Assembly—FIGS. 5A through 6B, 9A and 9C through 9E

Overall views of the second embodiment G2 geometry are given in FIGS. 5A and 5B. Shown are: the door panel assembly (closed) 51, door mount and support assemblies 52, door alignment and support track 53 and the door panel assembly (open) 54.

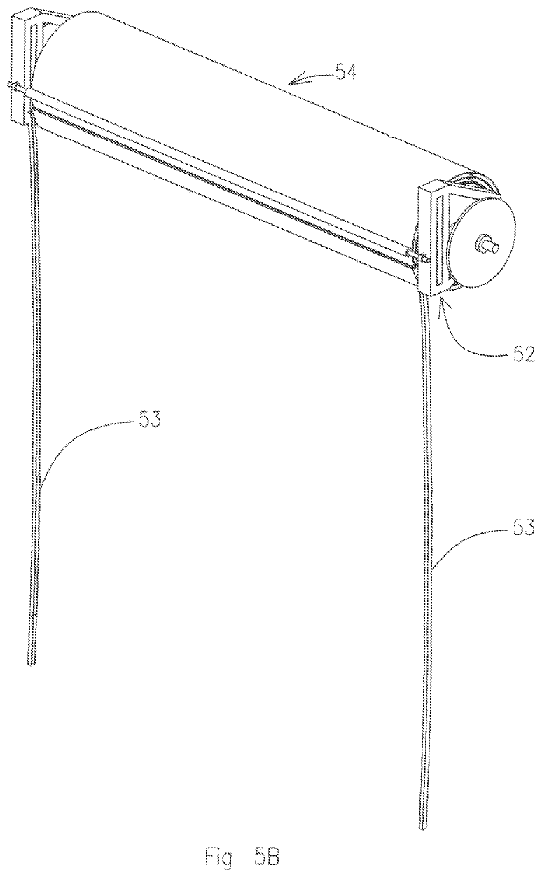

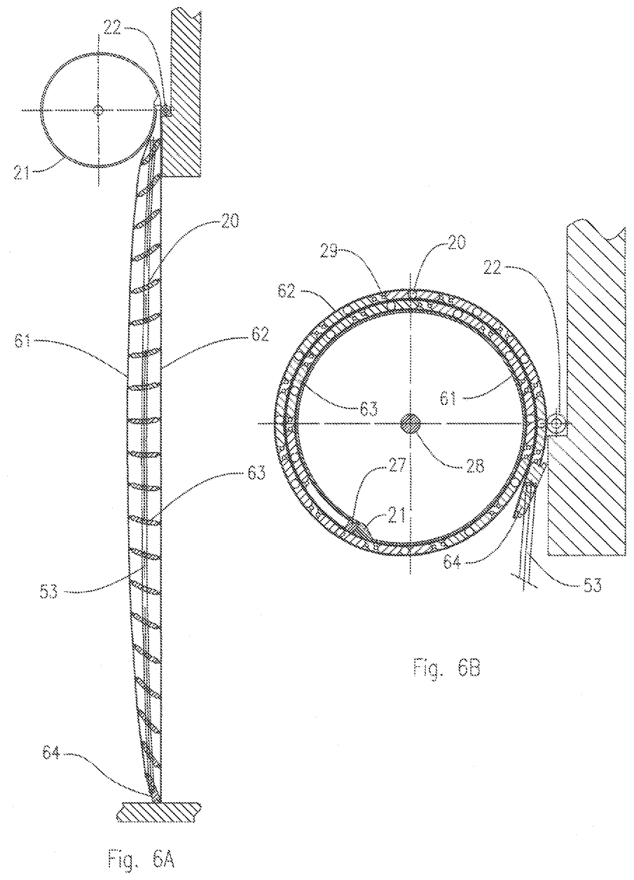

Details of the door panel assembly are illustrated in FIGS. 6A and 6B showing cross-sections of the G2 panels in the closed and open configurations, respectively. An inner surface elastic sheet 61 is connected to an outer surface elastic sheet 62 by a plurality of high aspect ratio curved webs 63 by means of hinges 29. The upper edges of both elastic sheets are rigidly connected to an anchor bar 27 which is, in turn, connected to a cylindrical mandrel 21 which rotates about an axle 28. The bottom-most web 64 is configured to be a floor contact seal. Support rollers 20 are attached to all of the curved web 63 ends, as well as the floor contact web 64 ends. Also shown are the support tracks 53 within which the support rollers 20 are confined when the door is closed. FIGS. 9A and 9C illustrate details of the anchor bar 27 and mandrel 21 connection by means of recessed screws 91. FIG. 9D shows details of the roller 20—track section 92 interface, where the track may be the “C” cross-section galvanized steel track commonly used for overhead door support applications. FIG. 9E illustrates a typical web 96—sheet 93, 94—roller 20 and hinge 95 interface for a partially open door.

A support and guide roller 22, which is connected to the door mount and support assemblies 52, is provided. It is noted that this roller does not transmit a large radial force to the rolled elastic sheets since shell transverse shear force is absent for circular cylindrical bending displacement of the thin elastic sheets.

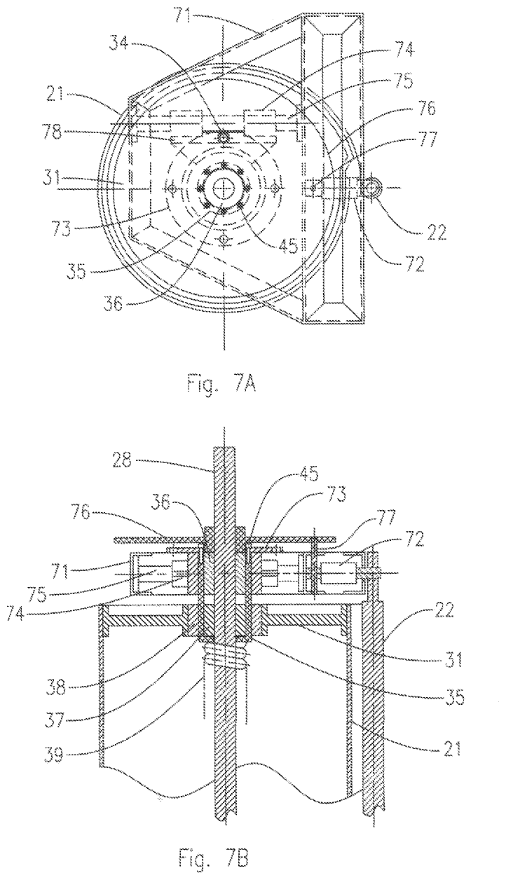

### Second Embodiment, Door Mount and Support Assemblies—FIGS. 7A through 8B, 9A, 9B

The second embodiment contains two nearly identical mount and support assemblies located at both ends of the mandrel. Designs of the assemblies differ due to inclusion of a weight counterbalance spring mechanism. The designs are designated “side A” and “side B” where side A includes a counterweight spring pretension and frame anchor mechanism and side B includes a spring-axle connection. The second embodiment support designs allow for horizontal displacement of the mandrel-axle assembly.

A side view of side A support assembly is shown in FIG. 7A. The corresponding cross-section is shown in FIG. 7B. Frameworks 71, shown as welded channel sections, provide support of the axle-mandrel assembly and counterweight pretension assembly through the frame bearing 36. The axle-mandrel assembly consists of: the axle 28, inner mandrel bearing 37, outer mandrel bearing 38, mandrel end 31 and mandrel 21. The counterweight pretension assembly consists of: the spring anchor sleeve 35, spring anchor plate 73, spring anchor sleeve screws 45 and spring anchor plate bolt 34. To obtain the desired counterweight spring torque, the spring 39, which is affixed to the spring anchor sleeve, is rotated via rotation of the spring anchor plate with axle rotation restrained. After the desired preload torque is obtained, the anchor plate is affixed to the linear bearing support 78 with the anchor plate bolt.

The significant difference between the first and second embodiment supports is that, for the second embodiment, the axle-mandrel assembly moves horizontally relative to the framework via a linear bearing assemblies and is regulated by cam systems. The reason for this movement is to assure correct tracking of the web rollers during operation of the door. A linear bearing assembly consists of two linear bearings 74 guided by a linear bearing shaft 75 and affixed to a linear bearing support 78 which, in turn, supports the frame bearing 36. Horizontal movement of the axle is controlled by a grooved cam plate 82, FIGS. 9A and 9B, which is affixed to the axle. Radius of the cam groove 90, which follows the cam pin 77, determines the horizontal position of the axle-mandrel assembly. The guide roller 22 is supported by the axially sprung support leg 72 which is attached to the support frame 71.

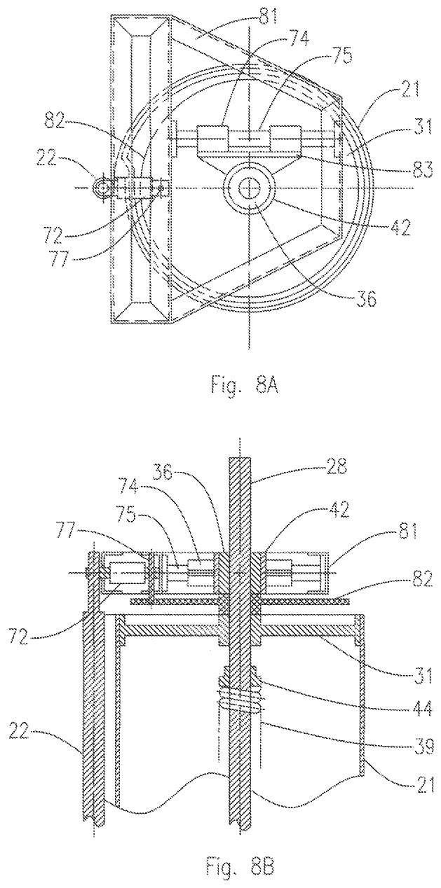

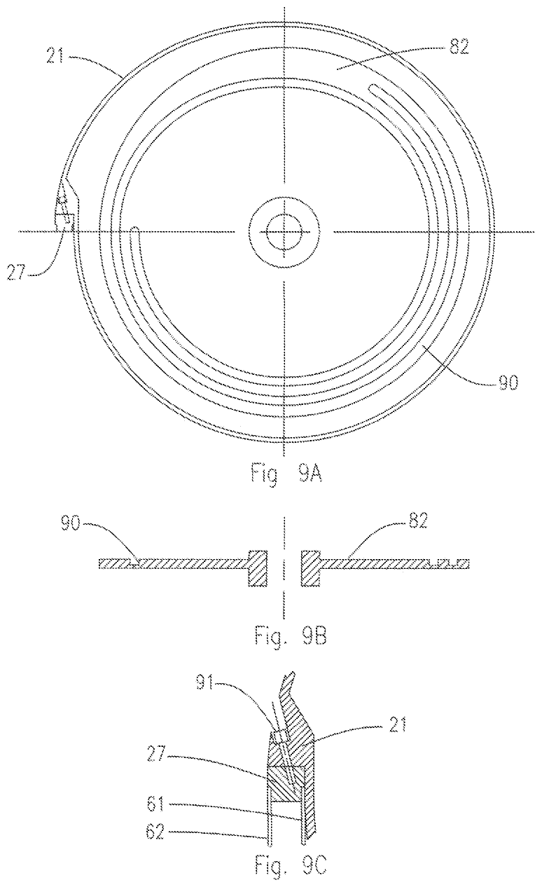

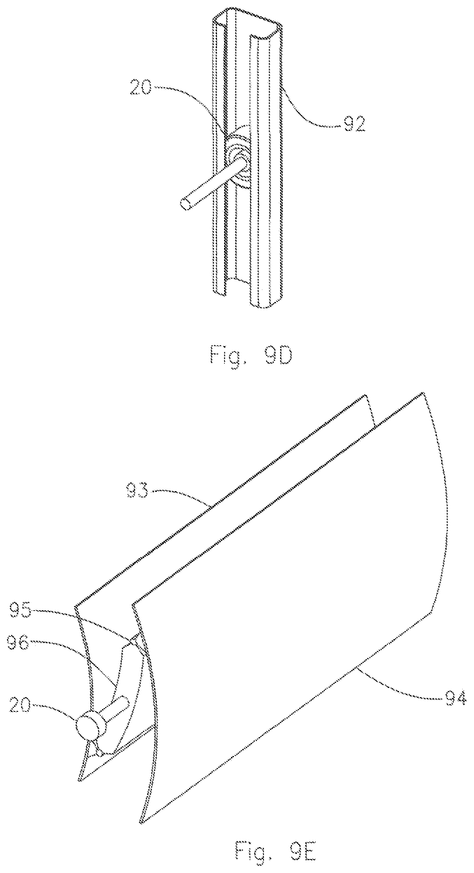

Side and cross-section views of the second embodiment side B support assembly are shown in FIGS. 8A and 8B, respectively. It is seen that a difference between Side B and side A support assembly is the omission of the counterweight pretension assembly and addition of the spring-axle connection flange 44. In addition, the inner and outer mandrel bearings are omitted in the side B support since the mandrel end 31 is affixed to the axle 28.

### First and Second Embodiments—Materials and Operation

The elastic surface sheets, 23, 61 and 24, 62, may be comprised of homogenous metallic material or of composite fiber reinforced polymer (FRP) construction. The webs, 25, 63, are subject to only in-plane stresses due to bending stress relief of the hinges 29, and may thus be constructed of light homogeneous materials or a FRP wrapped core. The hinges may be conventional mechanical hinges or constructed of flexible polymer composite. Various methods may be employed for hinge attachment to sheets and webs, including mechanical (rivets or spot welds) or adhesives. Also, the webs may be designed to include the hinge elements so that the only assembly attachments required are web-to-sheets.

Operation of both door embodiments is very simple where a torsional force is applied to either end of the axle which results in rotation of the axle-mandrel assembly and associated vertical motion of the door.

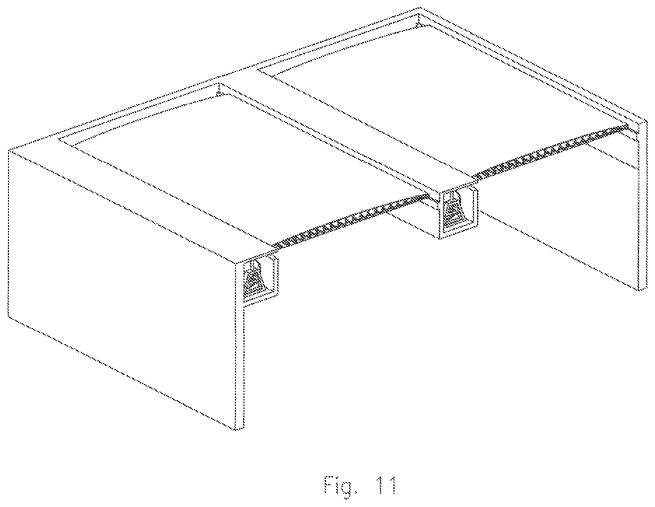

### First and Second Embodiments—Design Considerations—FIG. 10

A representative section of the rolled-up door is shown in FIG. 10 where Ri and Ro represent, respectively, inner and outer sheet rolled-up configuration radii, and ti and tₒ are corresponding sheet thicknesses. A requirement of both embodiments is that the maximum strains in the sheets remain less than an elastic design strain of the material comprising the sheets when the embodiment is in the partially open or fully open configurations and the sheets are bent around the supporting mandrel. For metallic materials, an appropriate design strain is 80 percent of the material yield strain or the endurance limit strain. For FRP materials subject to prolonged strain, an appropriate design strain is the creep-rupture limit which varies from 20 to 50 percent of the ultimate rupture strain, depending on the type of fiber and polymer used in the design.

Maximum elastic strain, e, in a circular cylindrically bent thin elastic sheet is given by the following well known relationship:

e=t/(2R),

where t is the sheet thickness and R is the cylindrical bend radius of the sheet. Maximum open embodiment strain, emax, is then,

emax=max{ti/(2Ri),to/(2Ro)}.

From this relationship, design t/R ratios are determined by equating emax with the sheet material design strain, as determined in the preceding paragraph.

After selection of Ri, Ro and web dimension W, constants k and C are computed according to relations 101, FIG. 10.

For first embodiment designs (geometry G1), the clear opening height, see FIG. 2A, is approximately equal to x+r, as given in 102, 103 and 104 (FIG. 10), where E(a, k) is an incomplete elliptic integral of the second kind which may be found in mathematical function tables or numerically calculated. Note that, for practical designs, the maximum angle, a, should be taken to be between 70 and 80 degrees. For second embodiment designs (geometry G2), the clear opening height, see FIG. 6A, is approximately equal to y+s, as given in 105, 106 and 107 (FIG. 10), where the integral defined by H(a, k) is not a common tabular function, but must be numerically calculated. In this case, it is noted that the maximum value of angle a is arcsin(k) so that H(a, k) remains real-valued (represents the maximum allowable rotation of the end web).

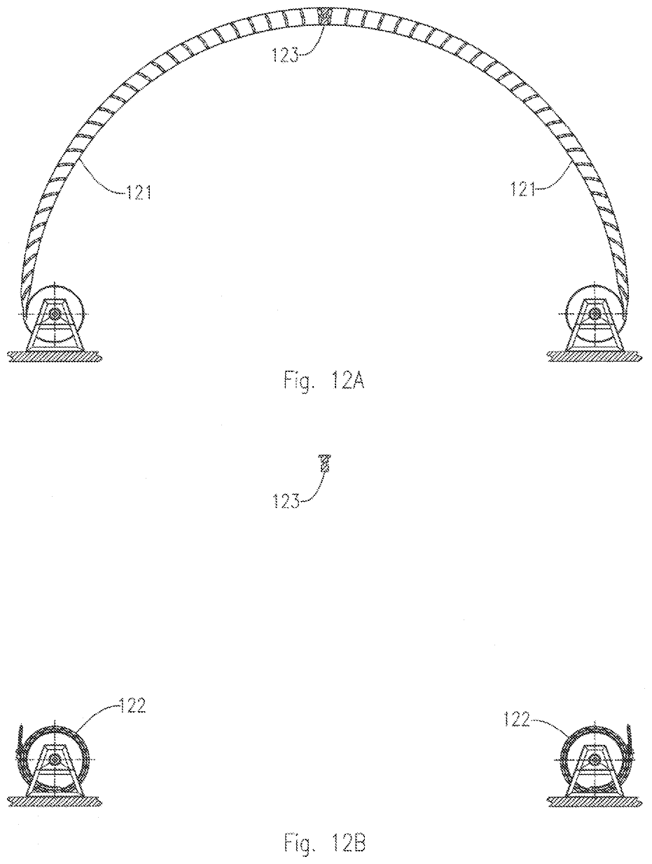

### Additional Embodiments—FIGS. 11 through 12B

Due to its very large lateral load resistance to weight ratio and weather tightness, the deployable shell is an excellent candidate for retractable roof design bases. FIG. 11 illustrates a conceptual stadium or gymnasium retractable roof application embodiment. Shown, in a cutaway view, are two retractable roof panels, each of which may be independently operated. The panels illustrated are of the geometry G1 type with the lower planar sheet being sealable with the base structure and the upper curved sheet capable of shedding rain or melted snow. Each entire retracted panel and associated structures and drive motor are contained within hollow roof support box beams. Web-roller support tracks, not shown in the figure, are attached to the roof support structure.

An additional retractable roof application embodiment is illustrated in FIGS. 12A and 12B. Shown are cross-sections of a conceptual green-house roof embodiment in closed, FIG. 12A, and fully retracted, FIG. 12B, configurations. In this embodiment, two geometry G1 retractable panels, 121 (closed) and 122 (retracted), are mounted to a floor slab and semi-circular support tracks, not shown, are attached to transverse end walls, not shown. Also included is an optional central roof beam 123 supported by the end walls, the purpose of which is to stabilize and strengthen the overall roof and wall structure. A translucent glass reinforced polymer could be used for construction of the retractable panels, the composition of which would allow transmission of the desirable sunlight bandwidths when the panels are in closed or partially closed configurations.

### First and Second Embodiments—Advantages

A number of advantages are evident in the first and second embodiments described above:

(a) Very high stiffness and strength to weight ratios of the closed configurations enable light weight embodiments to carry large environmental transverse loads, such as pressure induced by wind.

(b) Embodiment continuous sheet surfaces enable the closed embodiments to be weather tight and capable of forming static pressure boundaries.

(c) Air confined in the cells of the closed configurations enables natural insulation of transverse heat transfer in the embodiments.

(d) Embodiment construction is extremely easy with no requirements for use of specialized equipment.

(e) Embodiment installation and operation utilizes existing commercially available equipment.

### CONCLUSION, RAMIFICATIONS AND SCOPE

Two deployable shell roll-up door embodiment designs are disclosed herein. The embodiment designs are simple in concept and construction, yet have many potential uses which take advantage of the designs' unique capabilities:
in their closed configurations, they have a very large stiffness to weight ratio which enables applications requiring low weight, deformations and flutter;
in their closed configurations, they have a very high lateral load strength to weight ratio which enables applications requiring low weight and high resistance to lateral environmental loading;
in their closed configurations, they have good natural insulation to transverse heat flow due to air confined in the internal cells of the shell;
in their closed configurations, they are weather tight and capable, with proper edge sealing, of forming a differential pressure boundary such as could be used in an ultra-clean environment;
in their open configurations, they are compact cylinders; and
they are capable of rapid and quiet operation.

Although the above discussion contains many specificities, these should not be construed as limiting the scope of the embodiments, but as providing illustrations of some of several possible applications.

I claim:

1. A roll-up door system with large transverse load capacity to weight ratio, based on a deployable shell design, comprising:
a. a solid circular cylindrical axle (28), horizontally oriented, providing continuity to said roll-up door system;
b. a flexible door panel assembly (11, 14), comprising:
1. a rectangular inner surface elastic sheet (23) having an upper edge,
2. a rectangular outer surface elastic sheet (24) substantially parallel to said inner surface elastic sheet and having an upper edge,
3. a plurality of elongated hinges (29),
4. a plurality of substantially rigid elongated webs (25) having at least two parallel elongated edges and two ends, each of which is attached in a parallel manner, along both elongated edges, to said inner and outer elastic sheets by means of said hinges, where the spacing of said hinge connections, as measured on the surface of said inner elastic sheet, is less than the spacing of said hinge connections, as measured on the surface of said outer elastic sheet, thus sandwiching said webs between said elastic sheets,
5. a plurality of web support rollers (20) attached to the ends of said webs,
6. a sheet anchor bar (27) to which are attached the upper edges of said inner and outer elastic sheets,
7. a hollow substantially circular cylindrical mandrel (21), having two ends and an outer surface to which is attached said anchor bar so that said inner elastic sheet is nearest said mandrel axis,
8. a first mandrel end (31) attached to the first end of said mandrel and being radially supported by said axle,
9. a second mandrel end (31) attached to the second end of said mandrel and being supported by and attached to said axle;
c. a first door mount and support assembly (12) providing radial support of said axle, comprising:
1. a first support frame (30),
2. a first frame bearing (36) being coaxial with said axle and located between said first support frame and said axle;
d. a second door mount and support assembly (12) providing radial support of said axle, comprising:
1. a second support frame (41),
2. a bearing support ring (42) attached to said second support frame,
3. a second frame bearing (36) being coaxial with said axle and located between said bearing support ring and said axle;
e. a support and guide roller assembly providing guidance of said flexible door panel assembly, comprising:
1. a support and guide roller (22) contacting said flexible door panel assembly,
2. a first guide roller support leg (32) attached to said first support frame and providing elastic spring support of said guide roller,
3. a second guide roller support leg (32) attached to said second support frame and providing elastic spring support of said guide roller;
f. a weight balancing spring assembly, comprising:
1. a spring-axle connection flange (44) affixed to said axle,
2. a counter-weight spring (39) coaxial with said axle and attached to said spring-axle connection flange,
3. a spring anchor sleeve (35) coaxial with said axle, passing through said first mandrel end and attached to said counter-weight spring,
4. an inner mandrel bearing (37) located between said axle and said spring anchor sleeve,
5. an outer mandrel bearing (38) located between said spring anchor sleeve and said first mandrel end,
6. a spring anchor plate (33) being coaxial with said axle and contacting said first support frame,
7. a plurality of spring anchor sleeve screws (45) connecting said spring anchor sleeve with said spring anchor plate,
8. a first spring anchor plate bolt (34) and a second spring anchor plate bolt (34) connecting said spring anchor plate to said first support frame,
whereby, with said axle temporarily rotationally restrained and said spring anchor plate bolts temporarily removed, said spring anchor plate is rotated until a desired weight preload torque is achieved in said counter-weight spring, whereupon said spring anchor plate bolts are installed;
g. a first door alignment and support track (13) and a second door alignment and support track (13), curved along respective longitudinal axes, and entraining and supporting said web support rollers located on common ends of said webs, thus enabling said inner elastic sheet to be planar for said door closed configuration;
whereby, application of torsional force to said axle rotates said mandrel resulting in either closure of said roll-up door or opening of said roll-up door, depending on direction of application of said torsional force.

2. A roll-up door system with large transverse load capacity to weight ratio, based on a deployable shell design, comprising:
a. a solid circular cylindrical axle (28), horizontally oriented, providing continuity to said roll-up door system;
b. a flexible door panel assembly (51, 54), comprising:
1. a rectangular inner surface elastic sheet (61) having an upper edge,
2. a rectangular outer surface elastic sheet (62) substantially parallel to said inner surface elastic sheet and having an upper edge,
3. a plurality of elongated hinges (29),
4. a plurality of substantially rigid elongated webs (63) having at least two parallel elongated edges and two ends, each of which is attached in a parallel manner, along both elongated edges, to said inner and outer elastic sheets by means of said hinges, where the spacing of said hinge connections, as measured on the surface of said inner elastic sheet, is less than the spacing of said hinge connections, as measured on the surface of said outer elastic sheet, thus sandwiching said webs between said elastic sheets,
5. a plurality of web support rollers (20) attached to the ends of said webs,
6. a sheet anchor bar (27) to which are attached the upper edges of said inner and outer elastic sheets,
7. a hollow substantially circular cylindrical mandrel (21), having two ends and an outer surface to which is attached said anchor bar so that said inner elastic sheet is nearest said mandrel axis,
8. a first mandrel end (31) attached to the first end of said mandrel and being radially supported by said axle,
9. a second mandrel end (31) attached to the second end of said mandrel and being supported by and attached to said axle;
c. a first door mount and support assembly (52) providing radial support and horizontal alignment of said axle, comprising:
1. a first support frame (71),
2. a first linear bearing shaft (75) connected to said first support frame,
3. a first linear bearing (74) and a second linear bearing (74) supported by and coaxial with said first linear bearing shaft,
4. a first frame bearing (36) being coaxial with and located adjacent to said axle,
5. a first bearing support (78) connected to said first and second linear bearings and supporting said first frame bearing,
6. a first cam plate (76) containing a spiral cam groove and being coaxial with and connected to said axle,
7. a first cam pin (77) attached to said first support frame and constrained by said cam plate groove,
whereby, rotation of said axle results in corresponding rotation of said first cam plate and, due to spiral shape of said cam groove, a resulting horizontal motion of said axle;
d. a second door mount and support assembly (52) providing radial support of said axle, comprising:
1. a second support frame (81),
2. a bearing support ring (42) being coaxial with said axle,
3. a second frame bearing (36) being coaxial with said axle and located between said bearing support ring and said axle
4. a second linear bearing shaft (75) connected to said second support frame,
5. a third linear bearing (74) and a fourth linear bearing (74) supported by and coaxial with said second linear bearing shaft,
6. a second bearing support (83) connected to said third and fourth linear bearings and said bearing support ring,
7. a second cam plate (82) containing a spiral cam groove and being coaxial with and connected to said axle,
8. a second cam pin (77) attached to said second support frame and constrained by said cam plate groove,
whereby, rotation of said axle results in corresponding rotation of said second cam plate and, due to spiral shape of said cam groove, a resulting horizontal motion of said axle;
e. a support and guide roller assembly providing guidance of said flexible door panel assembly, comprising:
1. a support and guide roller (22) contacting said flexible door panel assembly,
2. a first guide roller support leg (72) attached to said first support frame and providing elastic spring support of said guide roller,
3. a second guide roller support leg (72) attached to said second support frame and providing elastic spring support of said guide roller;
f. a weight balancing spring assembly, comprising:
1. a spring-axle connection flange (44) affixed to said axle,
2. a counter-weight spring (39) coaxial with said axle and attached to said spring-axle connection flange,
3. a spring anchor sleeve (35) coaxial with said axle, passing through said first mandrel end and attached to said counter-weight spring,
4. an inner mandrel bearing (37) located between said axle and said spring anchor sleeve,
5. an outer mandrel bearing (38) located between said spring anchor sleeve and said first mandrel end,
6. a spring anchor plate (73) being coaxial with said axle and contacting said first support frame,
7. a plurality of spring anchor sleeve screws (45) connecting said spring anchor sleeve with said spring anchor plate,
8. a spring anchor plate bolt (34) connecting said spring anchor plate to said second bearing support,
whereby, with said axle temporarily rotationally restrained and said spring anchor plate bolt temporarily removed, said spring anchor plate is rotated until a desired weight preload torque is achieved in said counter-weight spring, whereupon said spring anchor plate bolt is installed;
g. a first door alignment and support track (53) and a second door alignment and support track (53), curved along respective longitudinal axes, and entraining and supporting said web support rollers located on common ends of said webs, thus enabling said outer elastic sheet to be planar for said door closed configuration;
whereby, application of torsional force to said axle rotates said mandrel resulting in either closure of said roll-up door or opening of said roll-up door, depending on direction of application of said torsional force.
